(19) United States
(12) Patent Application Publication
(10) Pub. No.: US 2026/0276918 A1
(43) Pub. Date: Sep. 17, 2026

(54) ALIGNMENT AND HOLDING MECHANISMS FOR HOLDING A FIBER ACCESS UNIT (FAU) IN A RECEPTACLE FOR CO-PACKAGED OPTICS

(71) Applicant: CORNING RESEARCH & DEVELOPMENT CORPORATION, CORNING, NY (US)

(72) Inventors: Michael De Jong, Fayetteville, PA (US); Wojciech Piotr Giziewicz, Berlin (DE)

(21) Appl. No.: 19/664,225

(22) Filed: Apr. 30, 2026

Related U.S. Application Data
(63) Continuation of application No. PCT/US2024/053354, filed on Oct. 29, 2024.
(60) Provisional application No. 63/546,393, filed on Oct. 30, 2023.
(60) Provisional application No. 63/603,680, filed on Nov. 29, 2023.

(51) Int. Cl. G02B 6/42

(52) U.S. Cl. CPC G02B 6/424

(57) ABSTRACT

An alignment and holding mechanism, for holding a fiber access unit in a receptacle, includes: a pivoting receptacle configured to receive a fiber access unit assembly, the receptacle having at least one receptacle pivot aperture defined therein; a base assembly, including at least one base pivot aperture; and a pivot element having a portion disposed within the receptacle pivot aperture and the base pivot aperture such that the pivoting receptacle is configured to rotate with respect to the base assembly.

### RELATED APPLICATION

This application is a continuation of International Patent Application Serial No. PCT/US2024/053,354 filed on Oct. 29, 2024, which claims the benefit of priority of U.S. Provisional Application Ser. No. 63/603,680 filed on Nov. 29, 2023, and U.S. Provisional Application Ser. No. 63/546,393, filed on Oct. 30, 2023, the content of which is relied upon and incorporated herein by reference in its entirety.

### BACKGROUND

The present disclosure generally relates to alignment and holding mechanisms for holding a fiber access unit (FAU) in a receptacle, particularly for co-packaged optics.

The growing demand for data and the challenges faced by data centers, such as reducing power consumption and cost per bit, have increased the significance of co-packaged optics (CPO). CPO, which involves integrating optical components and silicon photonics (SiP) on a single packaged substrate, holds great potential in addressing these challenges. In SiP, silicon is used as the optical medium, primarily in the near infrared (NIR) wavelength band around wavelengths of 1.31 μm and 1.55 μm, which are used in telecommunications. Advantages of SiP include the possibility of using existing semiconductor fabrication methods and infrastructure and the integration of electronics and photonics into a single chip as photonic integrated circuits (PICs) or at least into components that work closely together.

While progress has been made in developing components for CPO, the successful implementation of CPO also depends on the design and development of optical system solutions. Specifically, optimizing the complete optical system requires tailoring components and effectively managing and aligning fiber within the packaged substrate.

Managing waveguides plays a role in co-packaged optics. The fiber array unit (FAU), responsible for aligning fibers to waveguides is particularly important in CPO applications. Achieving low coupling losses requires tight positional tolerances and well-centered cores.

One known issue relates to the method of injecting or extracting light into/out of the SiP chips. In telecommunications, light is usually transported in fibers, which now have to be coupled to the SiP PICs. Here, three methods can be distinguished: Edge coupling-the waveguides of the SiP chip end and are interfaced with at the edge (side) of the SiP chip. Grating coupling—the PICs use grating couplers as an interface, where the light path is close to perpendicular to the surface of the chip. Grating couplers can be located anywhere on the chip's surface. Evanescent coupling—for evanescent coupling the waveguide in the silicon is brought into close proximity with a glass waveguide, so that the light can couple evanescently from the silicon to the glass and vice versa.

One of the difficulties with coupling light to SiP PICs is the difference in mode field diameters. Single mode fibers have a mode field diameter of about 10 μm, while modes in silicon waveguides may be of submicron dimensions because of the large refractive index of silicon (about 3.5), which leads to high losses if the fibers are coupled directly to the SiP waveguides. To reduce these losses, mode converters are required to scale the modes of the SiP to the size of the fiber modes.

While grating couplers can be designed such that they easily couple to single mode fibers, they have a limited bandwidth, so that they cannot support many different wavelengths (e.g., for WDM applications). Also, the fiber orientation perpendicular to the surface of the chip poses limits on the geometry/arrangements, in which these chips may be used.

Edge couplers require separate mode field converters to be able to couple to fibers. These may be realized in the silicon, as an additional interposer chip, where the conversion is realized through changing the waveguide size along the length, or through imaging optics.

With evanescent coupling, the mode field conversion can already be built into the geometry of the glass waveguides, to which fibers may then directly be coupled.

Accordingly, improved coupling methods and devices using alignment and holding mechanisms, particularly for co-packaged optics, are needed.

### SUMMARY

Embodiments disclosed herein are directed to alignment and holding mechanisms. Aspects of the embodiments pertain to a SiP chip using lensed grating couplers, i.e., the grating couplers are not intended to interface directly with fibers, but instead generate a near-vertical expanded beam for coupling.

According to one aspect, an alignment and holding mechanism for a receptacle and an FAU generally includes a metal frame placed around the receptacle and holds the FAU with a hinged cover. The cover may be latched to the metal frame through suitable mechanical features and may be disengaged to allow the FAU to be removed, making the connector re-matable. The cover also provides coarse alignment for the mechanism, so that the fine alignment structures are not damaged during mating and demating.

According to another aspect, an alignment and holding mechanism for a receptacle and an FAU generally includes mechanical attachment device to allow removable attachment of a multi-fiber FAU to a surface emitting silicon PIC. The device includes a base which is permanently attached to the PIC and a hinged carrier or cover which accepts the FAU, provides coarse alignment, and pivots the FAU into contact with the attached base and/or holds it in place. Advantages of this structure, include but are not limited to the combination of coarse and fine alignment, and ease of insertion and removal of the delicate FAU from the PIC.

According to yet another aspect, an alignment and holding mechanism for a receptacle and an FAU includes a pivoting receptacle configured to receive a fiber access unit assembly, the receptacle having at least one receptacle pivot aperture defined therein; a base assembly, including at least one base pivot aperture; and a pivot element having a portion disposed within the receptacle pivot aperture and the base pivot aperture such that the pivoting receptacle is configured to rotate with respect to the base assembly.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain the principles and operation of the various embodiments.

FIG. 1 is an isometric view of an alignment and holding mechanism for holding a fiber access unit (FAU) in a receptacle in accordance with embodiments disclosed herein;

FIG. 2 is an isometric top view of a base assembly included in the alignment and holding mechanism shown in FIG. 1;

FIG. 3A is an isometric side view of the embodiment of the alignment and holding mechanism shown in FIG. 1 in a first position;

FIG. 3B is an isometric side view of the embodiment of the alignment and holding mechanism shown in FIG. 1 in a second position with the FAU held therein;

FIG. 4 schematically illustrates how a portion of the alignment and holding mechanism can be positioned for z-axis placement;

FIGS. 5A, 5B, 5C, 5C′, 5D, and 5E are isometric views of another embodiment of alignment and holding mechanism in accordance with embodiments disclosed herein.

FIG. 6A is an isometric view of a base assembly for an alignment and holding mechanism for holding a fiber access unit (FAU) in a receptacle in accordance with embodiments disclosed herein;

FIG. 6B is an isometric bottom view of the base assembly shown in FIG. 6A;

FIG. 7 is an alignment and holding mechanism for holding a fiber access unit (FAU) in a receptacle in accordance with embodiments disclosed herein; and

FIG. 8 is an embodiment of an alignment and holding mechanism for holding a fiber access unit (FAU) in a receptacle in accordance with embodiments disclosed herein, including a cover.

The figures are not necessarily to scale. Like numbers used in the figures may be used to refer to like components. However, it will be understood that the use of a number to refer to a component in a given figure is not intended to limit the component in another figure labeled with the same number.

### DETAILED DESCRIPTION

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not limited to the described exemplary embodiments, but are to be controlled by the limitations set forth in the claims and any equivalents thereof.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

Cartesian coordinates may be used in some of the Figures for reference and are not intended to be limiting as to direction or orientation.

For purposes of description herein, the terms “upper,” “lower,” “right,” “left,” “rear,” “front,” “vertical,” “horizontal,” “top,” “bottom,” “side,” and derivatives thereof, shall relate to the disclosure as oriented with respect to the Cartesian coordinates in the corresponding Figure, unless stated otherwise. However, it is to be understood that the disclosure may assume various alternative orientations, except where expressly specified to the contrary.

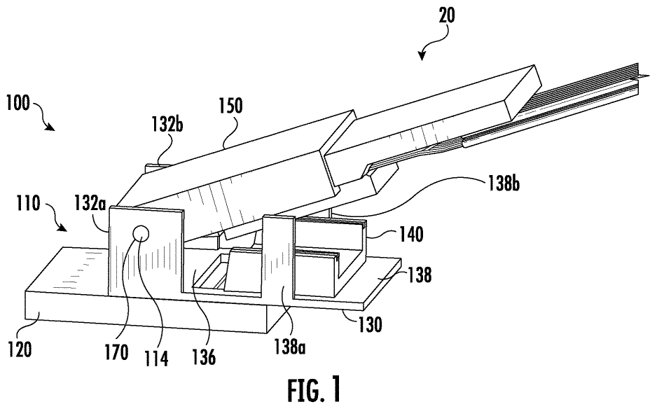

FIGS. 1, 2, 3A, and 3B illustrate one embodiment of an alignment and holding mechanism 100 for holding a FAU assembly 20 in a pivoting receptacle 150. Exemplary FAU assemblies are shown and described, inter alia, in U.S. Pat. Nos. 10,942,316, 11,194,107, 11,586,000, 11,567,285, and 11,415,753, which are incorporated herein by reference.

The overall design of the mechanism 100 allows for the insertion of the FAU 20 assembly into the pivoting receptacle 150 which then articulates and/or pivots into contact with one or more fixed portions of the mechanism 100. The one or more fixed portions are substantially and accurately aligned to the optics of a photonic integrated circuit (PIC) and configured to carry fine-alignment features needed to position the FAU assembly 20. These features are typically delicate, so the articulating/pivoting nature of the pivoting receptacle 150 is able to provide more coarse alignment and substantially prevent damage to the alignment structure of the FAU assembly 20. Most, if not all, of the materials of the mechanism preferably have coefficients of thermal expansion that are substantially matched to silicon.

The alignment and holding mechanism 100 includes a base assembly 110, having at least one base pivot aperture, an articulating or pivoting receptacle 150 configured to receive the FAU assembly 20, and a pivot element 170 having a portion disposed within the receptacle pivot aperture 112 and a base pivot aperture such that the pivoting receptacle is configured to rotate with respect to the base assembly 110.

The base assembly 110 includes a main base 120, a support base 130 that partially overhangs the main base 120, and a connector base portion 140 positionable within a portion of the support base 130. Preferably, these base components are configured as one or more subassemblies. In contemplated embodiments, however, integration of some base components may be desired.

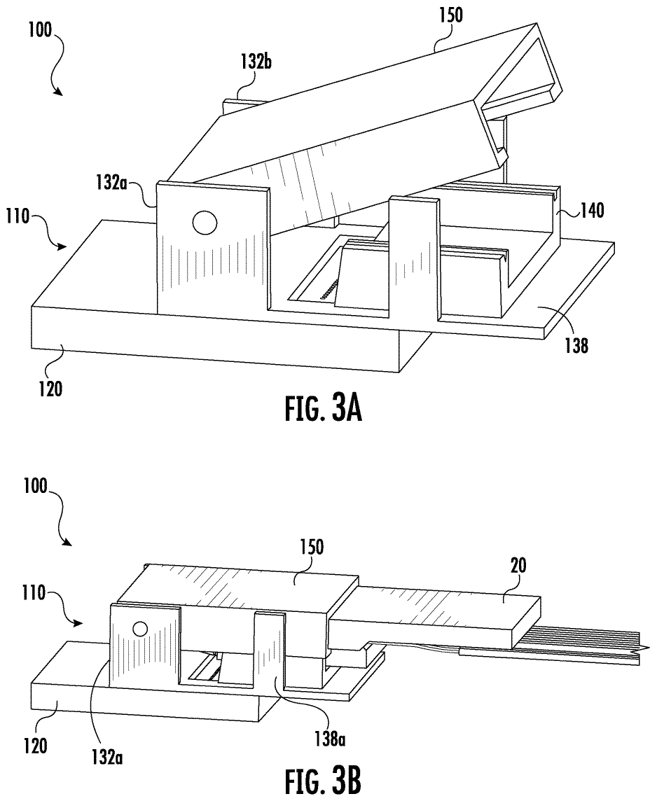

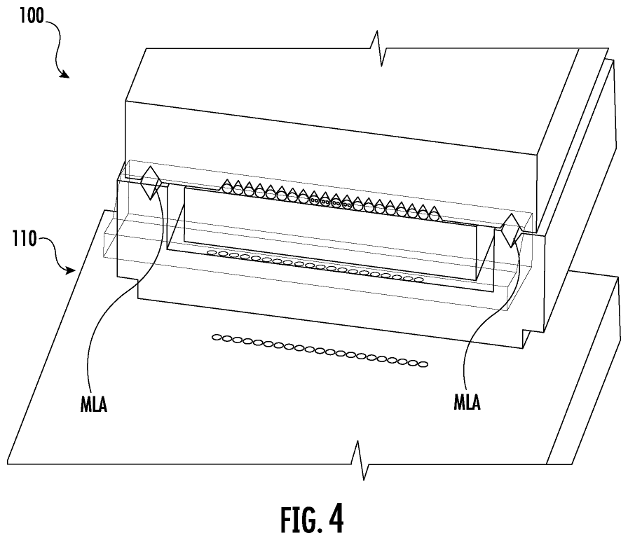

The main base 120 can be coupled to the support base 130 via any viable means or method. The support base 130 includes a plurality of proximate arms 132a, 132b, including arm apertures 134a, 134b for positioning of one or more pivot, hinge or spring elements therein. The support base 130 additionally includes a proximate base portion 136 positioned between the proximate arms 132a, 132b, a distal base portion 138, and distal arms 139a, 139b configured to support latches 138a, 138b that facilitate alignment of the pivoting receptacle 150 in the mechanism 100. In particular, the support latches 138a, 138b are configured to center the clamping force on the pivoting receptacle 150 despite the overhang nature of the support base 130. The FAU assembly is thus positionable within the pivoting receptacle, as shown particularly in FIGS. 1 and 3B.

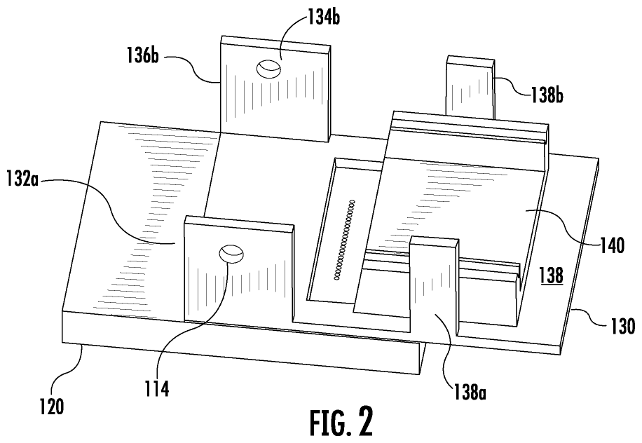

FIG. 2 is an isometric top view of the base assembly 110 included in the alignment and holding mechanism 100, showing further how each respective base assembly component may be configured within the mechanism.

FIG. 3A is an isometric side view of the embodiment of the alignment and holding mechanism shown in FIG. 1 in a first stage before insertion of the FAU assembly 20. The pivoting receptacle 150 allow for the FAU assembly to be installed with substantial ease. The articulation of the pivoting receptacle 150 further provide parallel “landing” of alignment rods in v-grooves of the FAU. FIG. 3B is an isometric side view of the embodiment of the alignment and holding mechanism shown in FIG. 1 in a second position with the FAU held therein.

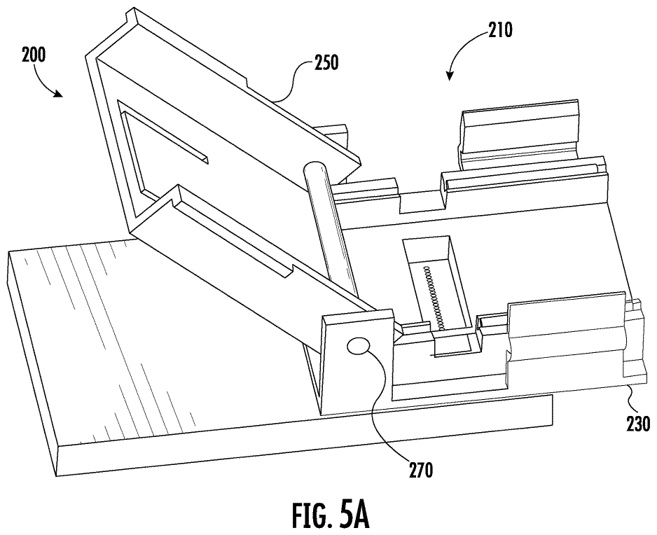

FIG. 4 schematically illustrates how a portion of the alignment and holding mechanism can be positioned for z-axis placement. Specifically, FIG. 4 shows how a micro-lens array (MLA) can be positioned in an overhung manner on both sides (i.e. via a hammer-head feature) to create a z-axis location secured against mechanical forces on fibers. Additional features of the micro-lens array with respect to the receptacle for more precise z-axis placement, however, is contemplated.

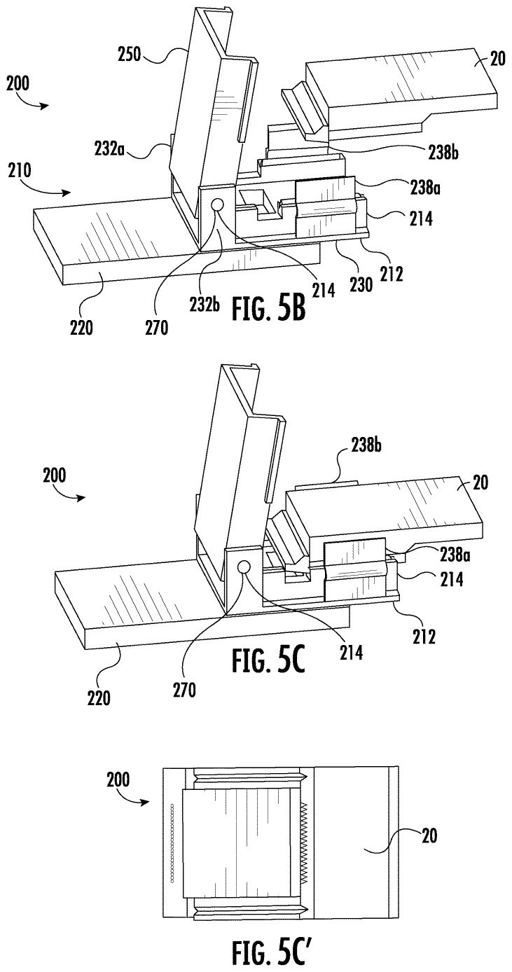

FIGS. 5A-5E illustrate isometric views of an alternative embodiment of an alignment and holding mechanism 200 at various stages of assembly with a FAU assembly 20. In this embodiment, a hinged cover may be used in the mechanism, which applies downward pressure on the FAU assembly after placement to retain it in place. With this embodiment, the mechanism is intended for use with a pick and place robot configured lay at least a portion of the FAU assembly 20 into place on the pivoting receptacle 250.

In FIG. 5A, the pivoting receptacle 250 is placed and adhesively attached to a PIC glass on Si bonding for CTE match. In FIG. 5B, the FAU assembly 20 is configured to load from above. The mechanism 200 preferably includes an overhanging micro-lens array (MLA) in a tapered slot that forms z-axis alignment (both coarse and fine) such that the FAU cover creates an x-y coarse alignment, as shown particularly in FIGS. 5C and 5C′.

As with the first embodiment, the overall design of the mechanism 200 allows for the insertion of the FAU 20 assembly into the pivoting receptacle 250 which then articulates and/or pivots into contact with one or more fixed portions of the mechanism 200. The one or more fixed portions are substantially and accurately aligned to the optics of the PIC and carries fine-alignment features needed to position the FAU assembly 20. These features are typically delicate, so the articulating/pivoting nature of the pivoting receptacle 250 is able to provide more coarse alignment and substantially prevent damage to the alignment structure of the FAU assembly 20. Most, if not all, of the materials of the mechanism preferably have coefficients of thermal expansion that are substantially matched to silicon.

The alignment and holding mechanism 200 includes a base assembly 210, having at least one base pivot aperture, an articulating or pivoting receptacle 250 configured to receive the FAU assembly 20, and a pivot element 270 having a portion disposed within the receptacle pivot aperture and the base pivot aperture such that the pivoting receptacle is configured to rotate with respect to the base assembly 210.

The base assembly 210 includes a main base 220, a support base 230 that partially overhangs the main base 220, and a connector base portion 240 positionable within a portion of the support base 230. Preferably, these base components are configured as one or more subassemblies. In contemplated embodiments, however, integration of some base components may be desired.

The main base 220 can be coupled to the support base 230 via any viable means or method. The support base 230 includes a plurality of proximate arms 232a, 232b, including arm apertures 234a, 234b for positioning of one or more pivot, hinge or spring elements therein. The support base 230 additionally includes a proximate base portion 236 positioned between the proximate arms 232a, 232b and a distal base portion 238 configured to support latches 238a, 238b that facilitate alignment of the pivoting receptacle 250 in the mechanism 200. The support latches 138a, 138b may also be configured to center the clamping force on the pivoting receptacle 250 despite the overhang nature of the support base 230.

In FIGS. 5D and 5E, the pivoting receptacle 250 is shown moving from an upright open position to a downward, closed position. Here, a spring element may also be included in the mechanism that allows for the pivoting receptacle to provide additional downward pressure on the FAU assembly 20.

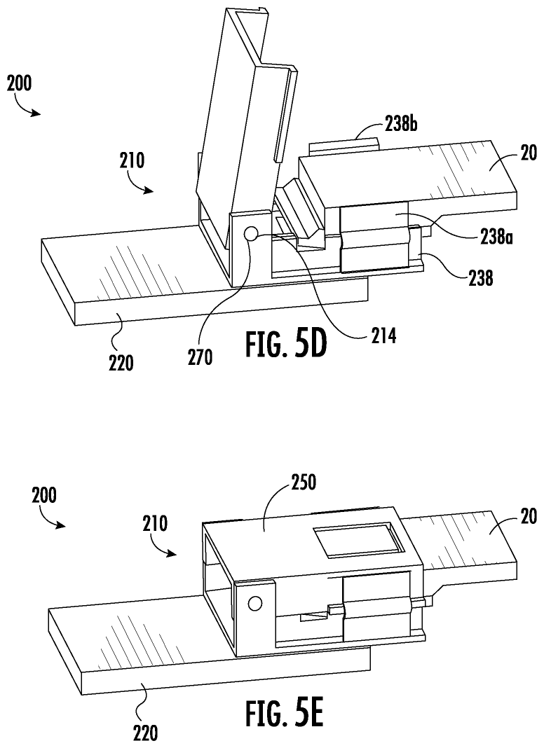

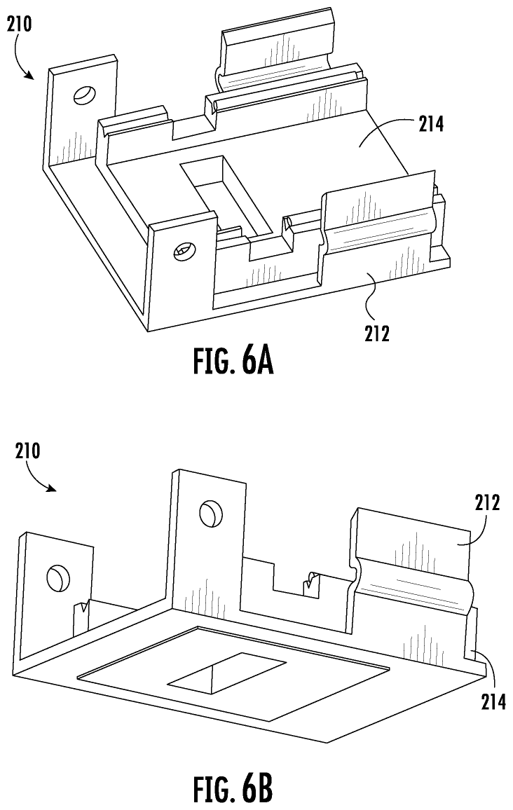

FIGS. 6A and 6B further illustrate portions of the mechanism 200, shown in FIGS. 5A-5E. This portion of the mechanism 200 includes a base support 212 and a base element 214. The base support 212 is preferably manufactured from a stamped metallic material and adhesively coupled to the base element 214. The base element 214 is preferably manufactured from precision glass. In this configuration, the base element 214 is configured to protrude from the base support 212 such that the base element 214 is configured to be bondable to Silicon PIC and metal to float above a PIC.

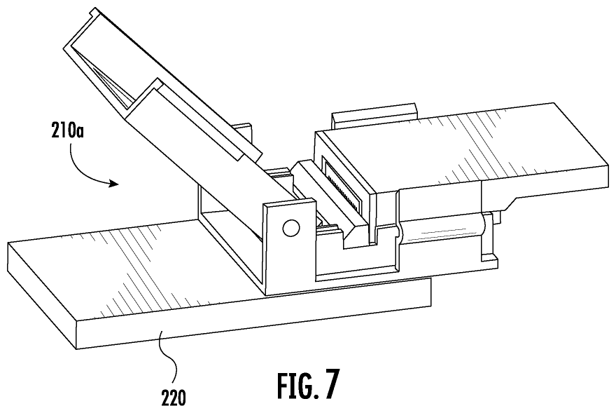

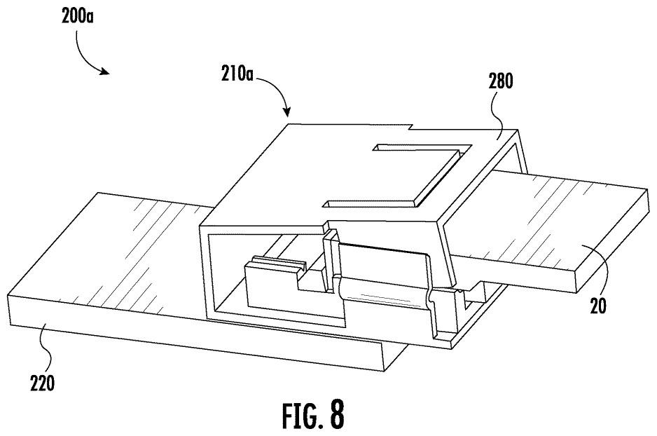

FIGS. 7 and 8 are alternative embodiments of an alignment and holding mechanism 200A for holding a fiber access unit (FAU) in a receptacle in accordance with embodiments disclosed herein, including a cover 280.

It will be apparent to those skilled in the art that various modifications and variations can be made without departing from the spirit or scope of the disclosed embodiments. Since modifications combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An alignment and holding mechanism for holding a fiber access unit in a receptacle, the mechanism comprising:
a pivoting receptacle configured to receive a fiber access unit assembly, the pivoting receptacle having at least one receptacle pivot aperture defined therein;
a base assembly, including at least one base pivot aperture, the base assembly further comprising a base support and a base element coupled to the base support, the base element protruding from the base support and being configured to be bonded to a silicon photonic integrated circuit such that the base support is spaced above the silicon photonic integrated circuit; and
a pivot element having a portion disposed within the receptacle pivot aperture and the base pivot aperture such that the pivoting receptacle is configured to rotate with respect to the base assembly.

2. The mechanism of claim 1, wherein the base assembly comprises:
a main base, a support base that partially overhangs the main base, and a connector portion positionable within a portion of the support base.

3. The mechanism of claim 2, wherein the support base comprises a plurality of proximate arms with each arm defining at least one arm aperture.

4. The mechanism of claim 3, wherein the at least one arm aperture is configured to receive the pivot element.

5. The mechanism of claim 3, wherein the support base further comprises a proximate base portion positioned between the proximate arms.

6. The mechanism of claim 3, wherein the support base further comprises a distal base portion comprising one or more latches that facilitate alignment of the pivoting receptacle the mechanism.

7. The mechanism of claim 6, wherein the one or more latches are configured to center a clamping force on the pivoting receptacle.

8. The mechanism of claim 1, wherein the base element is bondable to silicon.

9. The mechanism of claim 1 or claim 8, wherein the base element is adhesively coupled to the base support.

10. The mechanism of claim 1, further comprising a cover positioned over at least a portion of the pivoting receptacle.

11. An assembly, comprising: a fiber access unit assembly;
an alignment and holding mechanism, comprising:
a pivoting receptacle, having at least one receptacle pivot aperture defined therein, configure to receive at least a portion of the fiber access unit assembly;
a base assembly, including at least one base pivot aperture, the base assembly further comprising a base support and a base element coupled to the base support, the base element protruding from the base support and being configured to be bonded to a silicon photonic integrated circuit such that the base support is spaced above the silicon photonic integrated circuit; and
a pivot element having a portion disposed within the receptacle pivot aperture and the base pivot aperture such that the pivoting receptacle is configured to rotate with respect to the bas assembly.

12. The assembly of claim 11, wherein the base assembly comprises: a main base, a support base that partially overhangs the main base, and a connector base portion positionable within a portion of the support base.

13. The assembly of claim 12, wherein the support base comprises a plurality of proximate arms with each arm defining at least one arm aperture.

14. The assembly of claim 13, wherein the at least one arm aperture is configured to receive the pivot element.

15. The assembly of claim 13, wherein the support base further comprises a proximate base portion positioned between the proximate arms.

16. The assembly of claim 13, wherein the support base further comprises a distal base portion comprising one or more lates that facilitate alignment of the pivoting receptacle in the mechanism.

17. The assembly of claim 16, wherein the one or latches are configured to center acclaiming force on the pivoting receptacle.

18. The assembly of claim 11, wherein the base element is bondable to silicon.

19. The assembly of claim 11, wherein the base element is adhesively coupled to the base support.

20. The assembly of claim 11, further comprising a cover positioned over at least a portion of the pivoting receptacle.
